(19) United States
(12) Patent Application Publication
(10) Pub. No.: US 2022/0410635 A1
(43) Pub. Date: Dec. 29, 2022

(54) TIRE

(71) Applicant: BRIDGESTONE CORPORATION, Tokyo (JP)

(72) Inventor: Nobuyuki ISHIHARA, Tokyo (JP)

(73) Assignee: BRIDGESTONE CORPORATION, Tokyo (JP)

(21) Appl. No.: 17/780,774

(22) PCT Filed: Nov. 26, 2020
(86) PCT No.: PCT/JP2020/043928

§ 371 Date: May 27, 2022

(30) Foreign Application Priority Data
Nov. 29, 2019 (JP) 2019-216891

(51) Int. Cl. B60C 11/13; B60C 11/03; B60C 11/12

(52) U.S. Cl. CPC B60C 11/13; B60C 11/0309; B60C 11/1218; B60C 11/1236; B60C 2011/1213

(57) ABSTRACT

The tire includes a tread section (10) including a pair of circumferential main grooves (20), and the tread section (10) includes a center land region (CR) partitioned by the pair of circumferential main grooves (20) and a shoulder land region (SR) partitioned by one circumferential main groove (20) and a tread end (TE). The center land region (CR) forms a dense structure, in which no main groove extending along the tire circumferential direction (TC) is formed. The shoulder land region (SR) includes a block (40) partitioned by a plurality of shoulder lateral grooves (30) crossing in the tire width direction (TW). A sipe (50) extending in the tire width direction (TW) and having one end communicating with the one circumferential main groove (20) is formed in the block (40). A projection (43) projecting inward in the tire width direction is formed on a first groove wall (21) of the circumferential main groove (20) in a corner part (41) of the block (40) formed by intersection of the one circumferential main groove (20) and the shoulder lateral groove (30).

### TECHNICAL FIELD

The present invention relates to a tire with improved driving performance on ice and on snow, while reducing rolling resistance.

### BACKGROUND ART

Patent Document 1 describes a tire having a plurality of straight circumferential grooves and a plurality of lateral grooves are formed in a tread section, a shoulder land region is partitioned into a plurality of shoulder blocks, and a three-dimensional sipe is formed in the shoulder blocks. According to such tire, driving performance on ice and on snow may be improved.

### CITATION LIST

### Patent Literature

Patent Literature 1: Japanese Unexamined Patent Application Publication No. 2014-177237

### SUMMARY OF INVENTION

However, in the conventional tire, a drainage from the sipe to a circumferential main groove, which mainly handles the drainage of a ground surface, on an icy road surface may be suppressed by a water flow flowing in the circumferential main groove. Therefore, in the conventional tire, the drainage by the sipe in the tread surface may be insufficient, and further improvement in the drainage performance is desired.

Moreover, a block, partitioned by a plurality of the circumferential main grooves and the plurality of lateral grooves formed in the tread section, is desired to reduce rolling resistance further by suppressing deformation due to contact pressure of the tire.

An object of the present invention is to provide a tire that may improve on-ice driving performance by improving drainage from a sipe to a circumferential main groove while reducing rolling resistance of the tire.

A tire according to one or more embodiments of the present invention includes a tread section including a pair of circumferential main grooves extending in the tire circumferential direction. The tread section includes a center land region partitioned by the pair of circumferential main grooves, and a shoulder land region located outside in the tire width direction of the center land region partitioned by one circumferential main groove of the pair of circumferential main grooves and a tread end. The center land region forms a dense structure in which no main groove extending along the tire circumferential direction is formed. The shoulder land region includes a block partitioned by a plurality of shoulder lateral grooves crossing the shoulder land region in the tire width direction. The block is provided with a sipe extending in the tire width direction and having one end communicating with the one circumferential main groove. On a corner part of the block at an intersection of the one circumferential main groove and a first shoulder lateral groove included in the plurality of shoulder lateral grooves, a first groove wall of the one circumferential main groove is provided with a projection projecting inward in the tire width direction.

According to the above-described configuration, a tire that may improve on-ice driving performance by improving drainage from a sipe to a circumferential main groove while reducing rolling resistance of the tire is provided.

### BRIEF DESCRIPTION OF DRAWINGS

FIG. 1 is a partial plan view illustrating a tread pattern of a tread section 10.

FIG. 2 is a partial enlarged plan view of a shoulder land region SR including a circumferential main groove 20.

FIG. 3(a) is an enlarged perspective view of a portion of one groove wall 31 that forms a shoulder lateral groove 30 and includes an inclined surface 32.

FIG. 3(b) is an enlarged end view perpendicular to a tire axial direction TA, which illustrates a part of the inclined surface 32 of the groove wall 31 at a tire widthwise-inner position.

FIG. 3(c) is an enlarged end view perpendicular to the tire axial direction TA, which illustrates a part of the inclined surface 32 of the groove wall 31 at a tire widthwise-outer position.

FIG. 4(a) is an enlarged perspective view of a portion of a groove wall 31 according to a variant, the portion including an inclined surface 32A.

FIGS. 4(b) to 4(c) are enlarged end views perpendicular to the tire axial direction TA, each of which illustrates a part including the inclined surface 32A of the groove wall 31 according to the variant.

### DESCRIPTION OF EMBODIMENTS

Embodiments will be described below with reference to the drawings. It should be noted that the same functions and configurations are denoted by the same or similar reference numerals, and the description thereof is appropriately omitted.

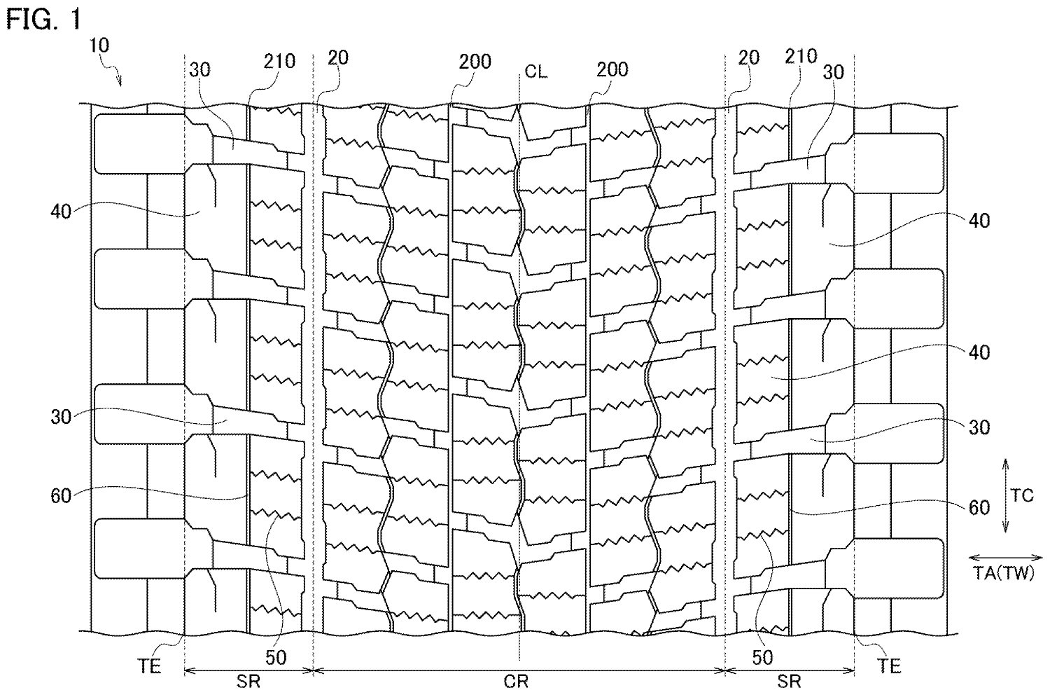

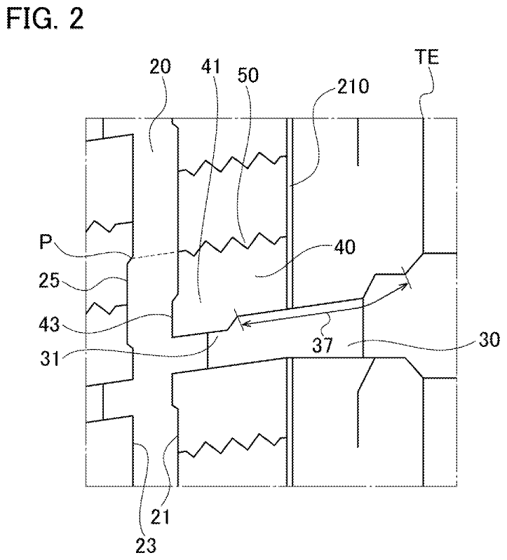

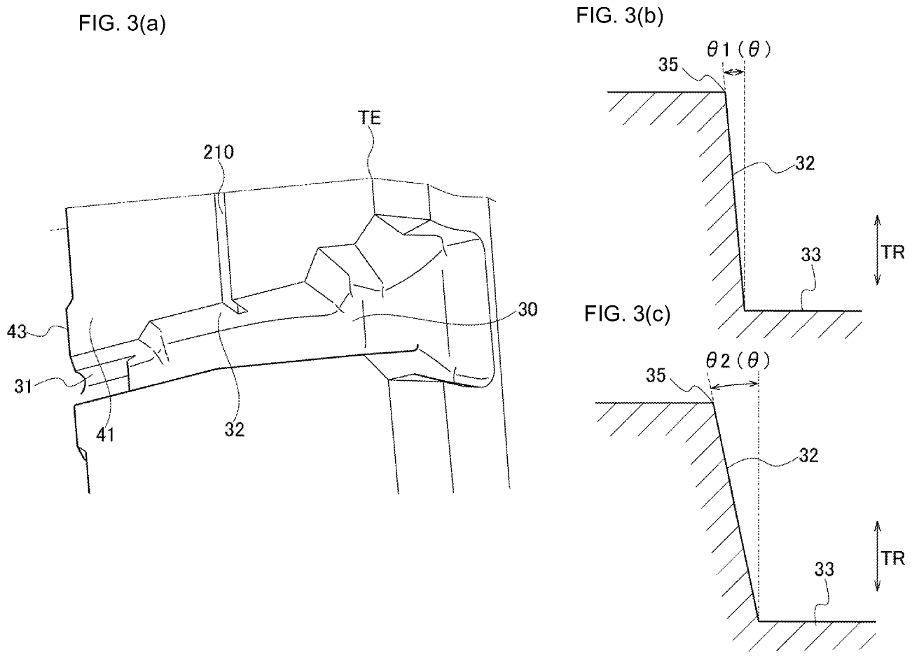

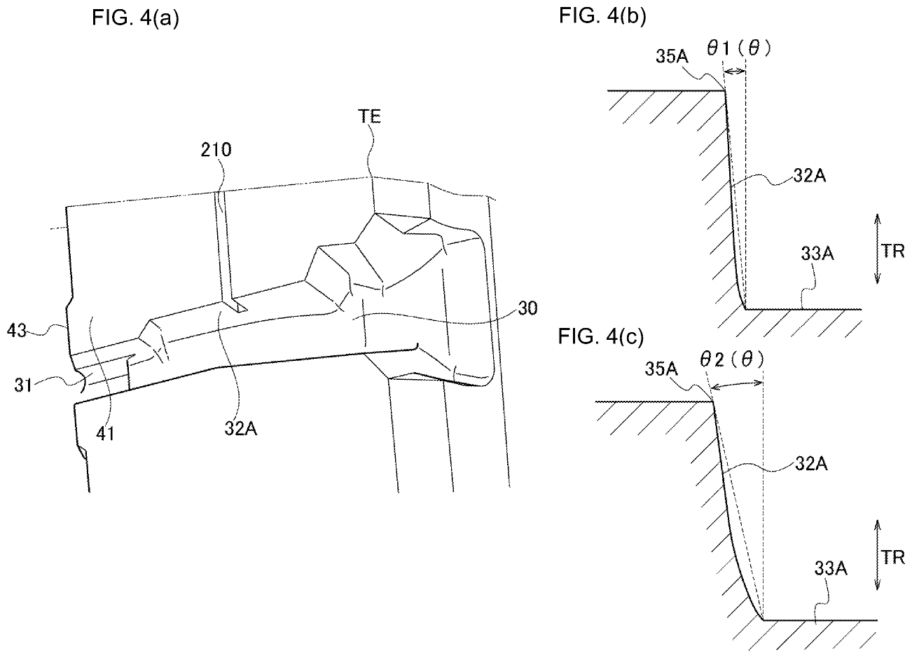

FIG. 1 is a partial plan view illustrating a tread pattern of a tread section 10 of a tire according to present embodiment. FIG. 2 is a partial enlarged plan view of a shoulder land region SR including a circumferential main groove 20. FIG. 3(a) is an enlarged perspective view of a part including an inclined surface 32 of one groove wall 31 forming a shoulder lateral groove 30. FIG. 3(b) is an enlarged end view perpendicular to a tire axial direction TA, which illustrates a part of the inclined surface 32 of the groove wall 31 at the tire-widthwise-inner position. FIG. 3(c) is an enlarged end view perpendicular to the tire axial direction TA, which illustrates a part of the inclined surface 32 of the groove wall 31 at a tire-widthwise-outer position. FIG. 4(a) is an enlarged perspective view of a part of a groove wall 31 according to a variant, the part including an inclined surface 32A. FIGS. 4(b) to 4(c) are enlarged end views perpendicular to the tire axial direction TA, each of which illustrates a part including the inclined surface 32A of the groove wall 31 according to the variant.

The tread section 10 is formed with a tread pattern in accordance with a performance required for the tire. In this embodiment, the tire is a studless tire that can be suitably used for trucks and buses (TB). The studless tire may be referred to as a snow tire or a winter tire. Alternatively, the tire may be a so-called all-season tire usable not only in winter but also in all seasons.

The tire is not necessarily used for a truck or a bus, but may be used for other types of vehicles, for example, a passenger automobile, a van, and a light-duty truck.

The tire according to the present embodiment includes a tread section 10 having a pair of circumferential main grooves 20 extending in the tire circumferential direction TC. The tread section 10 includes a center land region CR partitioned by the pair of circumferential main grooves 20, and a shoulder land region SR positioned outside a tire width direction TW of the center land region CR partitioned by one circumferential main groove 20 of the pair of circumferential main grooves 20 and a tread end TE. The center land region CR forms a dense structure in which no main groove extending along the tire circumferential direction TC is formed. The shoulder land region SR includes a block 40 partitioned by a plurality of shoulder lateral grooves 30 crossing the shoulder land region SR in the tire width direction TW. A sipe 50 extending in the tire width direction TW and having one end communicating with the circumferential main groove 20 is formed in the block 40. On a corner part 41 of the block 40 at an intersection of the one circumferential main groove 20 and a first shoulder lateral groove 30, a first groove wall 21 of the one circumferential main groove 20 is provided with a projection 43 projecting inward in the tire width direction TW. The first shoulder lateral groove 30 is a width direction groove included in the plurality of shoulder lateral grooves 30. The configuration of the tire according to the present embodiment will be described in detail below.

As illustrated in FIG. 1, the pair of circumferential main grooves 20 extending along the tire circumferential direction TC is formed in the tread section 10. In this embodiment, the pair of circumferential main grooves 20 are straightly formed. However, the pair of circumferential main grooves 20 may not necessarily be straight, such as coasting slightly in the tire width direction.

The tread section 10 is partitioned into a center land region CR where the tire width direction TW of which is partitioned by the pair of circumferential main grooves 20, and a shoulder land region SR located outside in the tire width direction TW of the center land region CR and partitioned by one circumferential main groove 20 of the pair of circumferential main grooves 20 and a tread end TE.

In the present embodiment, a circumferential groove having a groove width equal to a groove width of the one circumferential main groove 20 or a groove width wider than the groove width of the one circumferential main groove 20 is not formed in the center land region CR.

In other words, only a circumferential narrow groove 200 extending in the tire circumferential direction and having a groove width narrower than the circumferential main groove 20 is formed in the center land region CR. Therefore, in the center land region CR, the distance between adjacent land blocks (which may be called spacing or gap) is narrow. Therefore, in the center land region CR, a plurality of land blocks are densely arranged to form a dense structure with respect to arrangement of land blocks in a general tire of this type.

In the present embodiment, the groove width of the one circumferential main groove 20 is about 4.0 mm to 10.0 mm, and the groove width of the circumferential narrow groove 200 is about 1.5 mm to 4.0 mm.

A shoulder lateral groove 30 crossing in the tire width direction TW from the circumferential main groove 20 to the tread end TE is formed in at least one shoulder land region SR. In this embodiment, a plurality of the shoulder lateral grooves 30 are formed in the shoulder land region SR. The shoulder land region SR is partitioned into a plurality of blocks 40 by the plurality of the shoulder lateral grooves 30.

A sipe 50 extending in the tire width direction TW and communicating with the circumferential main groove 20 is formed in each block 40 of the shoulder land region SR. Here, the sipe is a narrow groove formed to have a groove width (for example, a groove width of 0.1 mm to 1.5 mm), which is configured to close in the ground plane when the tire is grounded. In this embodiment, the sipe 50 is a so-called three-dimensional sipe that is bent a plurality of times.

As illustrated in FIG. 2, on a surface forming a first groove wall 21 of the circumferential main groove 20 in each block 40, a projection 43 projecting inner side in the tire width direction TW is formed at a corner part 41, where the circumferential main groove 20 intersects the shoulder lateral groove 30.

In the present embodiment, the three-dimensional sipe 50 is not formed at a tire circumferential position where the projection 43 of each block 40 is formed. It should be noted that a sipe may be formed on a block 40 at a tire circumferential position where the projection 43 is formed, if the sipe has an end part in tire width direction TW on the circumferential main groove 20 side not opened to the circumferential main groove 20 at the projection 43.

Each block 40 is formed to have a circumferential narrow groove 210 extending in the tire circumferential direction TC and having a groove width narrower than the groove width of the circumferential main groove 20. The groove width of the circumferential narrow groove 210 formed in the shoulder land region SR may be the same as the groove width of the circumferential narrow groove 200 formed in the center land region CR at an upper limit, and may be the same as the groove width of the sipe at a lower limit. Specifically, the groove width of the circumferential narrow groove 210 is 0.1 mm to 4.0 mm.

As illustrated in FIG. 2, an outer end of the three-dimensional sipe 50 in the tire width direction TW may communicate with the circumferential narrow groove 210. A groove depth of the circumferential narrow groove 210 may be shallower than a groove depth of the shoulder lateral groove 30 as illustrated in FIG. 3(a).

As illustrated in FIG. 2, a groove wall 31 on the shoulder lateral groove 30 side at the corner part 41 of the block 40 may be formed in protruding shape protruding in the tire circumferential direction TC, the corner part 43 being a part where the projection 43 is formed. That is, the corner part 41 of the block 40 including the protruding shape protruding in the tire circumferential direction TC may protrude toward inner side in the tire width direction TW (toward an tire equatorial line side) and toward the tire circumferential direction TC side at the groove walls of the circumferential main groove 20 and the shoulder lateral groove 30. In the present embodiment, only one groove wall of the shoulder lateral groove 30 is formed to include the protruding shape protruding in the tire circumferential direction TC.

As illustrated in FIG. 2, in the second groove wall 23 of the circumferential main groove 20, a recess 25 recessed in the tire width direction TW is formed at a position opposed to the tire circumferential position of the first groove wall 21 where the projection 43 is formed. The intersection P between the second groove wall 23 and an extension line of the three-dimensional sipe 50 extending in the tire width direction TW is located in the recess 25, including an end part in the tire circumferential direction TC of the recess 25. The extension line of the three-dimensional sipe 50 extending in the tire width direction TW is illustrated by a broken line in FIG. 2.

As illustrated in FIGS. 3(a) to 3(c), the groove wall 31 of the shoulder lateral groove 30, which partitions the shoulder land region SR into a plurality of blocks 40, includes an inclined surface 32 with curved shape. In the cross section perpendicular to the tire axial direction, the inclination angle θ of the inclined surface 32, which has curved shape, with respect to the tire radial direction TR gradually increases from the inner side in the tire width direction TW to the outer side in the tire width direction TW. The inclination angle θ of the inclined surface 32 is an inclination angle from the groove bottom 33 to the tread surface 35.

For example, the inclination angle θ1 at the inner end of the curved inclined surface 32 in the tire width direction TW illustrated in FIG. 3(b) is 5° to 10°. The inclination angle θ2 at the outer end of the curved inclined surface 32 in the tire width direction TW illustrated in FIG. 3(c) is 5° to 20°. However, the inclination angle θ of the curved inclined surface 32 is selected in a range satisfying a condition that the inclination angle θ is gradually increased from the inclination angle 81 at the inner end in the tire width direction TW to the inclination angle θ2 at the outer end in the tire width direction TW.

Although the contents of the present invention have been described in accordance with embodiments, it will be apparent to those skilled in the art that the present invention is not limited to these descriptions and that various modifications and improvements are possible.

In the end surface perpendicular to the tire axial direction illustrated in FIGS. 3(b) and 3(c) of the present embodiment, the inclined surface 32 is inclined linearly from the groove bottom 33 of the groove wall 31 to the surface 35 of the tread section 10. However, the inclined surface 32 with curved shape is not limited to the embodiment illustrated in FIGS. 3(a) to 3(c) as long as the surface from the groove bottom 33 to the surface 35 of the tread section 10 is inclined. For example, as in a variant illustrated in FIGS. 4(a) to 4(c), an inclined surface 32A with curved shape may have an end face, the end face perpendicular to the tire axial direction, inclined from a groove bottom 33 of the groove wall 31 to a tread surface 35 and curved to be convex downward, as illustrated in FIGS. 4(b) and 4(c).

Further, as illustrated in FIG. 1, the tread pattern formed on the tread section 10 of the tire according to the present embodiment has a pattern in which the tire rotation direction is designated so that the effect is remarkably exhibited during driving. However, the tread pattern is not limited to this. For example, in a case where it is desirable to have a structure that exhibits the effect in a good balance between driving and braking, a pattern inverted at the tire equatorial line CL may be used.

A rubber used for the tread section 10 may be made of an appropriate material in consideration of on-snow driving performance and wear resistance, and is not particularly limited. However, a material that may contribute to a reduction of rolling resistance (RR) of the tire may be used. Specifically, the rolling resistance coefficient (RRC) is preferably 7.5 or less.

(Action/Effect)

In this embodiment, as illustrated in FIG. 1, a dense structure, in which a plurality of land blocks are densely arranged in the center land region CR, is formed. This structure is a structure in which the center land region CR is partitioned by the circumferential narrow grooves 200. Therefore, the blocks or ribs partitioned by the circumferential narrow grooves 200 support each other along the circumferential direction during deformation, and deformation of the blocks or ribs in the tire width direction TW is suppressed. Therefore, uneven wear resistance in the center land region CR can be improved. Further, the rolling resistance of the tire can be reduced.

When the center land region CR has the dense structure, in which a plurality of land blocks are densely arranged, deformation of the center land region CR in the tire width direction TW is suppressed. As a result, the ground pressure in the shoulder land region SR is relatively increased. Accordingly, deformation of the shoulder land region SR becomes large. For this reason, in a tire in which the center land region CR has a dense structure in which a plurality of land blocks are densely arranged, it is important to improve the performance of draining water generated from an ice surface in contact with the shoulder land region SR in order to improve the on-ice driving performance of the tire.

In this embodiment, as illustrated in FIGS. 1 and 2, the three-dimensional sipe 50 extending in the tire width direction TW and having one end communicating with the circumferential main groove 20 is formed in the block 40 formed in the shoulder land region SR, and the projection projecting inward in the tire width direction TW is formed on the first groove wall 21 of the circumferential main groove 20 at the corner part 41 of the block 40 where the circumferential main groove 20 and the shoulder lateral groove 30 intersect.

According to this configuration, the three-dimensional sipe 50 absorbs water generated from the ice road surface. The water absorbed by the three-dimensional sipe 50 is drained into the circumferential main groove 20. However, even when the three-dimensional sipe 50 is formed, if the water flow in the circumferential main groove 20 is fast, there is a possibility that the drainage from the three-dimensional sipe 50 to the circumferential main groove 20 may become insufficient. In contrast, in the present embodiment, the projection 43 is formed on the first groove wall 21 of the circumferential main groove 20 in the corner part 41 of the block 40. With this configuration, the water flow in the circumferential main groove 20 is moderated, and the drainability from the three-dimensional sipe 50 to the circumferential main groove 20 is sufficiently secured.

Thus, in the present embodiment, wear resistance and uneven wear resistance can be improved while reducing the rolling resistance of the tire. Further, the on-ice driving performance of the tire can be improved.

In this embodiment, the sipe 50 is a three-dimensional sipe. When the sipe 50 is a three-dimensional sipe, the water absorbing performance of the sipe improves and water generated between the shoulder land region SR and the road surface can be absorbed more quickly.

Further, as illustrated in FIG. 2, in the tire according to the present embodiment, the three-dimensional sipe 50 is not formed in the tire circumferential direction position of the block 40 where the projection 43 is formed. That is, sipes opening to the circumferential main grooves 20 are not formed in the projections 43. According to this configuration, the rigidity of the projection 43 is secured, and the water flow in the circumferential main groove 20 can be moderated more reliably.

In the present embodiment, the recess 25 recessed in the tire width direction TW is formed at the tire circumferential position on the second groove wall 23 of the circumferential direction main groove 20 opposed to the tire circumferential position where the projection 43 is formed on the first groove wall 21. The intersection P between the second groove wall 23 and the extension line of the three-dimensional sipe 50 extending in the tire width direction TW is located in the recess 25, including the end part in the tire circumferential direction TC of the recess 25.

According to this configuration, the water flow in the circumferential main groove 20 can be moderated without reducing an amount of water flowing in the circumferential main groove 20. That is, according to this configuration, the drainage performance can be further improved.

In the present embodiment, a circumferential narrow groove 210 extending in the tire circumferential direction TC is formed in the block 40, and the other end of the three-dimensional sipe 50 communicates with the circumferential narrow groove 210. Since the circumferential narrow groove 210 is formed on the block 40, the block 40 can be deformed in the tire circumferential direction. Therefore, according to the present embodiment, the uneven wear resistance of the tire may be improved. Further, drainage from the other end of the three-dimensional sipe 50 to the shoulder lateral groove 30 is made possible, and drainage performance may be further improved.

In the present embodiment, a groove wall of the shoulder lateral groove 30 at the corner part 41 of the block 40 may be formed in protruding shape protruding in the tire circumferential direction TC, the corner part 43 being a part where the projection 43 is formed. According to this configuration, an intrusion of water from the circumferential main groove 20 into the shoulder lateral groove 30 is suppressed, and the water flow in the shoulder lateral groove 30 drained from the circumferential main groove 20 side to the tread end TE side can be moderated. Thus, drainability from the circumferential narrow groove 210 to the shoulder lateral groove 30 is secured.

This application claims priority under Japanese patent application 2019-216891, filed Nov. 29, 2019, the entire contents of which are incorporated herein by reference.

Thus, although embodiments of the invention have been described, it should not be understood that the arguments and drawings forming part of this disclosure are intended to limit the invention. Various alternative embodiments, embodiments, and operational techniques will be apparent to those skilled in the art from this disclosure.

### REFERENCE SIGNS LIST

10 TREAD SECTION

20 CIRCUMFERENTIAL MAIN GROOVE

21 FIRST GROOVE WALL OF CIRCUMFERENTIAL MAIN GROOVE

23 SECOND GROOVE WALL OF CIRCUMFERENTIAL MAIN GROOVE

25 RECESS

30 SHOULDER LATERAL GROOVE (LATERAL GROOVE)

31 ONE GROOVE WALL FORMING SHOULDER LATERAL GROOVE

32 CURVED INCLINED SURFACE

33 GROOVE BOTTOM

35 TREAD SURFACE

40 BLOCK

41 CORNER PART

43 PROJECTION

50 THREE-DIMENSIONAL SIPE (SIPE)

210 CIRCUMFERENTIAL NARROW GROOVE

CL TIRE EQUATORIAL LINE

CR CENTER LAND REGION

SR SHOULDER LAND REGION

θ INCLINATION ANGLE

TE TREAD END

TA TIRE AXIAL DIRECTION

P INTERSECTION OF EXTENSION LINE OF THREE-DIMENSIONAL SIPE AND SECOND GROOVE WALL

1. A tire comprising a tread section including a pair of circumferential main grooves extending in a tire circumferential direction, wherein
the tread section includes: a center land region partitioned by the pair of circumferential main grooves; and a shoulder land region located outside in a tire width direction of the center land region and partitioned by one circumferential main groove of the pair of circumferential main grooves and a tread end,
the center land region forms a dense structure, in which no main groove extending along the tire circumferential direction is formed,
the shoulder land region includes a block partitioned by a plurality of shoulder lateral grooves crossing the shoulder land region in the tire width direction,
the block is provided with a sipe extending in the tire width direction and having one end communicating with the one circumferential main groove, and
on a corner part of the block at an intersection of the one circumferential main groove and a first shoulder lateral groove included in the plurality of shoulder lateral grooves, a first groove wall of the one circumferential main groove is provided with a projection projecting inward in the tire width direction.

2. The tire according to claim 1, wherein, at a tire circumferential position on a second groove wall of the one circumferential main groove corresponding to a tire circumferential position where the projection is formed, a recess recessed inward in the tire width direction is formed.

3. The tire according to claim 2, wherein an intersection between the second groove wall and an extension line of the sipe extending in the tire width direction is arranged in the recess, including an end part in the tire circumferential direction of the recess.

4. The tire according to claim 1, wherein, the sipe is not formed at a tire circumferential position of the block where the projection is formed.

5. The tire according to claim 4, wherein, at a tire circumferential position on a second groove wall of the one circumferential main groove corresponding to a tire circumferential position where the projection is formed, a recess recessed inward in the tire width direction is formed.

6. The tire according to claim 5, wherein an intersection between the second groove wall and an extension line of the sipe extending in the tire width direction is arranged in the recess, including an end part in the tire circumferential direction of the recess.

7. The tire according to claim 1, wherein a circumferential narrow groove having a groove width narrower than respective groove widths of the pair of circumferential main grooves is formed in the block, and
the other end of the sipe communicates with the circumferential narrow groove.

8. The tire according to claim 1, wherein a groove wall of the first shoulder lateral groove at the corner part of the block, where the projection is formed, includes a projecting profile protruding in the tire circumferential direction.

9. The tire according to claim 1, wherein the sipe is a three-dimensional sipe.
